(19) United States
(12) Patent Application Publication
(10) Pub. No.: US 2005/0235553 A1
(43) Pub. Date: Oct. 27, 2005

(54) Rodent elimination system

(76) Inventor: Kenneth Daniel Rail, Gainesville, GA (US)

Correspondence Address: GREG O'BRADOVICH, P.C., 295 CULVER STREET, SUITE A, LAWERENCEVILLE, GA, 30045, US

(21) Appl. No.: 11/111,103

(22) Filed: Apr. 21, 2005

Related U.S. Application Data
(60) Provisional application No. 60/565,741, filed on Apr. 27, 2004.

(51) Int. Cl. A01M 23/00; A01M 19/00

(52) U.S. Cl. 43/58

(57) ABSTRACT

A rodent elimination system that continuously attracts, euthanizes, and stores numerous rodents for extended periods of time. The system typically includes a housing having an upper section and a lower section. The upper section typically includes a heated baiting device that interacts with the temperature sensitive bait to emit varying degrees of scent to attract a rodent. The upper section includes a euthanizing chamber having a rodent detector array. The lower section typically includes a freezer unit having a disposable bag for long term storage of euthanized rodents. A freezer door typically separates the upper and lower sections to allow both physical and thermal isolation.

Priority based on U.S. Provisional Patent Application, Ser. No. 60/565,741, filed Apr. 27, 2004, and entitled “Rodent Elimination System” is claimed.

### BACKGROUND

I. Field of the Invention

The present invention relates generally to the field of pest control and more particularly to a system for rodent elimination, temporary storage and disposal.

II. Description of the Related Art

Rats, mice and other rodents create several problems in modern society, ranging from minor nuisances to major catastrophic events. Researchers have studied whether or not the plague could occur again. There are still thousands of cases on the bubonic plague reported worldwide. The Plague is caused by the bacterium Yersinia pestis which is carried by the fleas that reside on rodents. Studies show that up to 30% of native wild rodents carry the plague. Most of these rodents live in the suburbs rather than the city. Larger species such as the Norway rat that have invaded cities normally keep the smaller native species out of the city. If the infected rodents were to move into the cities due to severe drought or some other reason, the fleas would leave the infected rodent when it dies and seek other blood sources such as the Norway rat thus infecting them. Once the cycle began, it would quickly spread throughout the Norway rat population. New York for example, has an estimated 96 million rodents, that's 12 rats per person, and these rodents come out at night by the hundreds of thousands, and during the day by the tens of thousands. Humans would be exposed to infected fleas and a major disaster would ensue.

One problem with the traditional methods of culling rat populations is that the fleas leave the dead rodent bodies in search of another host and that host could be human. Cambridge University Health Researchers have suggested that the traditional methods of culling rat populations could actually increase the spread of an outbreak of plague because the problem of killing the infected fleas is not addressed with current methods. Many health organizations today are working on the possibility that they could have another plague outbreak and while research continues, no vaccine has been developed to date. Rats are known to carry more than 100 different diseases which are spread by the fleas, the rat droppings, and rat bites.

It is important to note here that most of the rodent problems in the United States are actually being caused by invasive species that have been introduced accidentally and on purpose. Preliminary research on this problem led to the discovery that there are many other types of invasive vertebrates that are causing similar problems of food/crop destruction, disease, and endangering native species. The Norway Rat and the Nutria Rodent are both invasive species introduced into this country both accidentally and on purpose. A major source of entryway has been, and continues to be the shipping industry.

Battling the growing rat population is costing Americans more than $19 billion dollars a year. In major cities such as New York, Washington D.C., Chicago, Beverly Hills, and others, the rat problems have reached epidemic proportions.

Several other problems related to rodent infestation persist.

It is estimated that ⅓ of all structural fires are caused by rats gnawing through wires inside building walls. The problems' caused by the exploding population of rats is not limited to those who reside in the poorest areas of the country. This serious problem crosses all socio-economic levels. In states, cities and counties across the country “Rat Summits” are being held to discuss ways that the rat population can be significantly reduced while protecting humans and the environment.

Hantavirus Pulmonary Syndrome is on the rise in the US and is spread through the urine and droppings of mice and rats.

Rats also transmit Murine Typhus fever, rat bite fever, salmonellosis, Weils disease, trichinosis, melioidosid, brucellosis, tuberculosis, rabies, foot-and-mouth disease and many others totaling more than 100. The diseases are transmitted from droppings, fleas, and bites.

Rats in Anchorage Alaska are killing seabirds by the thousands.

Rats and Nutria Rodents are destroying thousands of acres of wetlands and causing major damage in the national parks.

Rats/mice destroy up to ½ of the worlds' food each year, including ⅓ of the US food supply. A single rat leaves 25,000 droppings per year. For all of the food that is eaten by rats/mice, more than double that amount must be destroyed because of contamination from the urine, droppings, and fleas and mites that live on the rats/mice.

Current methods of rat elimination do not address the problems associated with decay, smell, spreading of disease, sanitary clean-up, and not killing the fleas on the rats' body so that they leave the dead rat in search of another host or multiple hosts. If, for example, a rat is carrying 50 fleas and is killed the fleas leave its dead host and could infect up to 50 other rats.

Rodent elimination has never been effectively accomplished. Every method devised has many short-comings and dangers. Control methods based on poisons are somewhat effective but have many terrible side effects.

Poisons are not an acceptable method of control due to the fact that when the rodents die, they decay, smell terrible, and continue to spread disease. Any parasitic organisms such as fleas, mites, bacteria, and viruses can survive long enough to be picked up by other rodents, or worse, transmitted to a human host. Most poisons take 4 or 5 days to kill the rodent. Other animals including pets may consume the poison or the rodent either before or after it dies and they themselves become poisoned and die. This poison may also find its way into food, either at home, or in industry. New York City has discovered that poisoning of rodents actually increased the populations by making more food available for the survivors which in turn initiated a surge in breeding. Also, when you place up to 4000 poison baits out at a time, the rats eat the poison, crawl off and die, and then decay. Upon decaying the 4000 doses of poisons are released into the environment. The food industry is not allowed to use poison in its rodent control efforts due to the risk of poisoning the food supply. The chance of spreading disease to both humans and other rodents is still present.

Mechanical traps are effective but have several unacceptable deficiencies. First, no means of safely storing dead rodents at the catch site until removal has been accomplished. Using available trapping technology, the individuals operating the traps must check them daily to make sure a trapped rodent does not die and decay. They expose themselves to many deadly organisms when disposing of the rodent. Depending on the trap technology used, rodent body fluids may be splattered, further increasing the spread of disease. Second, using traditional trapping methods and equipment, sufficient manpower to handle the large number of rodents in cities is very expensive. Thus the use of poisons has increased to an alarming rate and is still not keeping up with the breeding rate of the rodents. Third, the bait used for mechanical traps becomes ineffective in a short amount of time and must be replaced, usually daily. Live catch traps work by trapping either single or multiple rodents in a mechanical trap and holding them until emptied. If these are not emptied on a daily basis, they also have the same problems of rotting, contamination, infected fleas escaping and a tendency to jam. Snap traps are very messy and cause additional spread of disease by splattering body fluids. They also have the same problems of rotting and contamination when not checked often enough. All of the above methods also create hazards related to human handling and rodent disposal. The chance of spreading disease to both humans and other rodents is still present.

The glue strip method is one which causes the rodent to become stuck on a glue strip until it dies and/or is removed. If the strip trap is checked prior to the rodent dying, the rodent must be drowned in a barrel of water or killed in some other fashion. If the strip traps are not checked often enough the rodent begins to rot and smell and disease can quickly begin to spread. Even if the glue strip is checked when the rodent gets stuck to it, the chance of spreading disease is still present.

Antifreeze/water/oil traps are designed to drown rodents when they fall into a container. They also have the same problems of rotting and contamination when not checked often enough. Antifreeze is extremely dangerous to people, animals, and the environment severely limiting their use. Water traps, if not emptied daily breed bacteria and mosquitoes.

Single use electrocution traps kill the rodent by zapping it with electricity. They also have the same problems of rotting and contamination when not checked often enough. If not constantly monitored they quickly become ineffective because they can only hold one rodent at a time.

Ultrasonic devices use the method of high frequency noise to frighten away mice and rats. Initially this works, but within a short period of time the rodents become accustomed to the noise and they return. Even if ultrasonic devices did work, they do not eliminate rodents they just send them to someone else

None of the methods in use today address the problems associated with rot, smell, flea, and disease issues. These methods also leave the dead rodents scent behind which causes other rodents to sense danger and avoid the traps. Each and every method that has a measurable level of effectiveness exposes people to disease causing organisms and fleas.

### SUMMARY

In general, the invention features a rodent elimination system that continuously attracts, carries out euthanasia, and stores numerous rodents for extended periods of time. By freezing the rodents, the system kills 100% of the fleas, most of the bacteria, place the viruses in a dormant less contagious state, and eliminates dead rodent scent so that the trap continues to attract more rodents. The system allows a method of disposal that is sanitary and is accomplished by simply lining the freezer with a plastic bio-barrier bag. The system solves many of the problems associated with all of the current rat control technology available today. The system typically includes a housing having an upper section and a lower section. The upper section typically includes a baiting device. A heated tube in the baiting device interacts with the temperature sensitive bait to emit varying degrees of scent that can attract a rodent into the upper section. The upper section further includes a euthanizing chamber having a rodent detector array. The lower section typically includes a freezer unit, ideally in a sub-zero range to allow long term storage of euthanized rodents. The freezer unit can be cooled in a variety of implementations as discussed further in the description below. A freezer door typically separates the upper and lower sections to allow both physical and thermal isolation.

In general, in one aspect, the invention features a rodent elimination system, including a housing having an upper section and a lower section, a heated baiting device located in the upper section, a euthanizing chamber having a rodent detector array located in the upper section, a freezer unit located in the lower section and a freezer door typically separating the upper and lower sections.

In one implementation, the system further includes a heated tube located in the baiting device.

In another implementation, the system further includes temperature sensitive bait located within the baiting device.

In another implementation, the system further includes a constriction system located within the euthanizing chamber.

In another implementation, the system further includes an electrocution device located within the euthanizing chamber.

In still another implementation, the freezer unit is cooled by Peltier devices.

In yet another implementation, the freezer unit is cooled by super cold CO2.

In another implementation, the freezer unit is cooled by liquid nitrogen.

In another implementation, the freezer unit is cooled by Freon refrigerant.

In another implementation, the system further includes an exoskeleton located on the exterior of the housing.

In another implementation, the system further includes a system status display.

One advantage of the invention is that the system catches, kills and holds multiple medium sized rats in between emptying (2 to more than 100 depending on trap size).

Another advantage of the invention is that it keeps rats frozen until removed with no decaying rat, no smell, and no spread of disease or contamination.

Another advantage of the invention is that the system kills the disease carrying fleas before they can leave the dead rat and find another host.

Another advantage of the invention is that the system can be sized for use in homes, industry, city and national parks, sewers, alleyways, restaurants, food storage facilities, ports, farms, homes, in-doors or outdoors, places of low to heavy infestations.

Another advantage of the invention is that it allows an efficient handling method of dead rodents with no special clean-up required.

Another advantage of the invention is that it contains no poisons to leak out and spread.

Another advantage of the invention is that it is environmentally friendly.

Another advantage of the invention is that the system can be operated from readily available power sources such as AC electrical power, Solar, Fuel Cell, or batteries

Another advantage of the invention is that the system includes low operating and maintenance costs and has a long life span.

Another advantage of the invention is that there are reductions in food losses, spread of rat-borne disease, costs of rat control, and rat damage repair.

Another advantage of the invention is that the system can be sized to hold in excess of 500 pounds of frozen rodents before they need to be emptied.

Another advantage of the invention is that the system can be used on ships entering ports as well as at port facilities that can greatly diminish the continued introduction of these destructive pests.

Other objects, advantages and capabilities of the invention will become apparent from the following description taken in conjunction with the accompanying drawings showing the preferred embodiment of the invention.

### BRIEF DESCRIPTION OF THE DRAWINGS

FIG. 1 illustrates an embodiment of an rodent elimination system.

### DETAILED DESCRIPTION

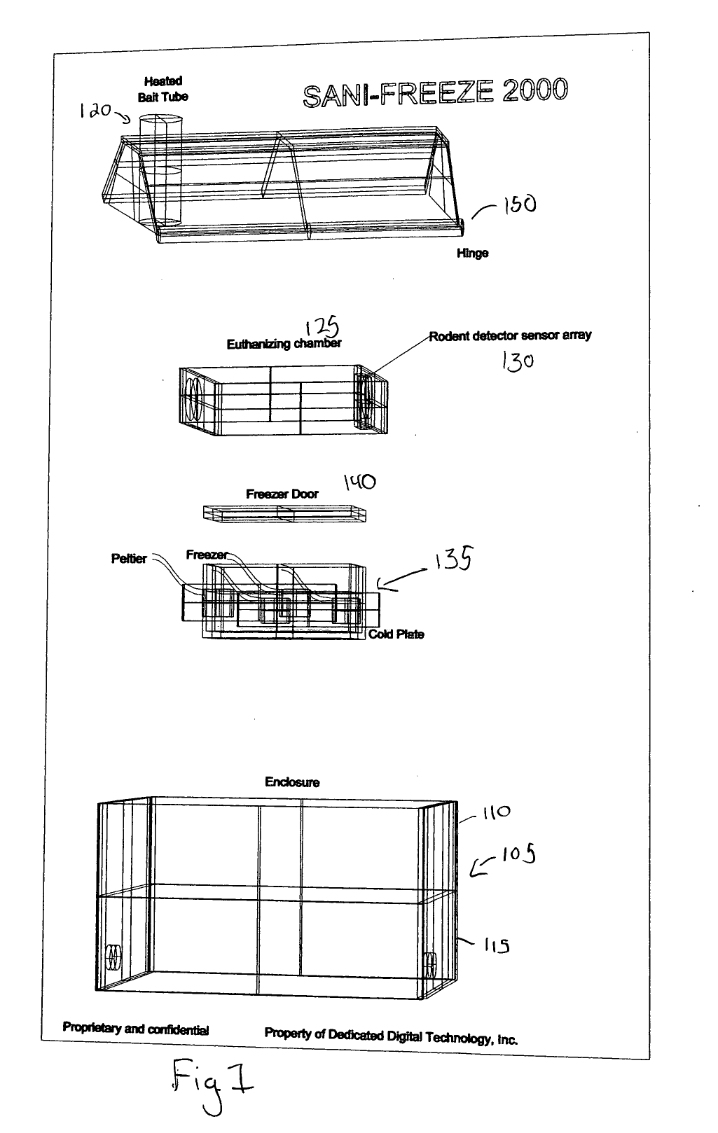

Referring to the drawings wherein like reference numerals designate corresponding parts throughout the several figures, reference is made first to FIG. 1 that illustrates an embodiment of an rodent elimination system 100.

The system 100 typically includes a housing 105 having an upper section 110 and a lower section 115. The upper section 110 typically includes a baiting device 120. In a typical embodiment, the baiting device is a heated tube having scented bait, as discussed further in the description below. The heated tube interacts with the temperature sensitive bait to emit varying degrees of scent that can attract a rodent into the upper section. The upper section 110 further includes a euthanizing chamber 125 having a rodent detector array 130, both of which are discussed in further detail in the description below.

The lower section 115 typically includes a freezer unit 135, ideally in a sub-zero range to allow long term storage of euthanized rodents. The freezer unit 135 can be cooled in a variety of implementations as discussed further in the description below. A freezer door 140 typically separates the upper and lower sections 110, 115, to allow both physical and thermal isolation.

In typical operation of the system 100, a rodent enters the upper section 105, by being attracted by the bait scent. A door (described further below) swings shut behind the rodent. The sensor array 130, which can include a laser sensor, senses the rodent and applies a current (in one implementation) that can stun the rodent. The freezer door 140 then opens that allows the rodent to fall into the lower section 115, into the freezer unit 135, that can freeze the rodent within minutes. The freezer door 140 closes and the system 100 is prepared for the next rodent. The lower section 115 can hold large numbers of rodents and can be sized accordingly depending on need. The person checking the system 100 can lift a hinged cover 150 on the upper section 105 to expose the disposal bag having the eliminated frozen rodents. The bag can be removed and a new one placed.

The requirements of the system 100 can vary depending on location and target rodent. System power for control and freezing may come from standard AC, DC storage batteries, Solar, Fuel Cell, CO22, LN2, or a combination of these. In typical embodiments, three basic sized systems are contemplated: small size for the homeowner; medium for the pest control industry; and large, for cities and other outdoor locations. Those skilled in the art appreciate that many size iterations are further contemplated.

For the average household, a system 100 that holds 6 mice or 2 medium size rodents is typically sufficient. Storing of the rodents and an audible alarm for notification that a rodent has been trapped, allows the home self trapper to safely eliminate their rodents. The rodents are deposited into a plastic bag by the system 100 and frozen for later disposal at the trappers' convenience, such as on trash day. A flashing light and/or audible alarm alerts them that they have rodents present in the system 100.

For commercial and military applications, especially food processing and warehouse storage facilities that choose to perform their own rodent control, a system 100 that eliminates and stores 24 mice or 8 medium sized rodents is sufficient. Larger systems 100 that hold up to 100 rodents handles the elimination of major infestations. A suitable device and method of notifying the department responsible is also typically required. If they have regular walk-through checks, a flashing light and/or audible alarm alerts them that they have rodents present in the system 100. The indicating device also signals the number in the system 100 with a beep and/or flash sequence equal to the number of rodents present, which can typically be tracked by the number of freezer door 140 cycles, for example. If the systems 100 are to be unattended, another method such as radio frequency, modem, or satellite, can be used.

To handle large populations of rodents such as in New York and other major cities, the same technology can be integrated into super systems 100 that hold up to 500 rodents. These systems 100 can be designed to blend with the outdoor environment to be placed near or combined with dumpsters and in sewers. In general, it is appreciated that micro to large scale applications are contemplated.

By using a programmed scent release subsystem, the problem of bait becoming infective can be addressed. In a typical embodiment, the scent is released by warming a scent pellet or liquid periodically to release scent attractant from the heating device 120.

There is an appreciation that there are certain rodents, particularly certain mice that are endangered and protected species. In some areas where these protected and/or endangered species live other, larger invasive species have emerged. For these situations the system 100 is designed with sensors in the first part of the entry way that can be set to only allow certain size rodents into the euthanasia chamber 125 where they cannot escape. If the controls are set in this fashion and a small mouse that may fit the endangered or protected list enters, it cannot enter the euthanasia chamber 125 and an audible alarm/vibrator activates to frighten it out of the system 100. Other options may be that this system 100 cannot be used in certain areas. However, research indicates that these areas are few and there remains a huge market for this system 100 where no protected species of mice reside.

There are various other features of the system 100 that are contemplated in the various embodiments and are now described.

The basic shape and color of the exterior of the system 100 can be varied for specific implementations. Base shape and color choices depend on target environment. As an example, the outer enclosure of the housing 105 can be shaped and colored as a box for warehouse installations, a pipe for sewers, a large rock for outdoor usage. To successfully trap rodents, the enclosure must be visually acceptable to the rodents. If the system 100 resembles its' surroundings, it is not seen as threatening by the rodents. Furthermore, if the system 100 resembles a feeding source, such as a trash can, the rodents are visually attracted to the system 100. Another plus is to have an enclosure that is visually attractive to humans in some settings. In a typical embodiment, a modular exoskeleton can be formed that are attached housing 105. The use of exoskeletons provides a cost effective way to have the system 100 function in different environmental settings with a simple, inexpensive skin change. The exoskeleton provides protection against ultraviolet radiation, mechanical damage to the working components, and adds another level of thermal insulation. Once the rodents are visually attracted, a scent is used to lure them inside. The entrance hole to the system 100 is designed to allow only the rodents to enter which prevents other animals/pets from entering as well as prevent children from reaching inside. The largest Norway rat only needs as much as 1½ inch to enter.

The baiting system and method can also have various iterations. In order to lure the rodents inside, the use of a baiting system is required. The baiting system, including the heated device 120 and scented bait, provides an attraction to rodents. The formulation of the scented bait can release targeted scents upon application of heat. Life-of-bait can be set at a prolonged interval such as 3 months. Additional heat is introduced into the attractant area to further attract rodents during cool nights and winter. The bait is located above the euthanasia chamber 125 out of reach of the rodent. The bait pellet may be layered with different layers having different scents so the rodents do not learn to associate a particular scent with the system 100.

The system 100 bait can be composed of a liquid or pellet concentrate which is activated using heat. Rodents respond better to changes in scent so the primary approach is a multi-scent bait pellet. This pellet is constructed using multiple layers of scent formulations so that over a period of a month or more, several scent changes occur. The pellet is simply dropped into a bait tube (heated device 120) and gravity feed to the heat element. The pellet has a very low solids content that leaves minimal residue.

Several euthanasia methods are further contemplated. The system 100 can use several different methods of euthanasia. One method is mentioned above, that is, the use of electrical current. In another implementation, the method recommend by the American Veterinary Medical Association's Panel is gassing them with CO2 This method basically puts them to sleep due to high CO2 levels in their blood. It is the same as the constriction method used by some snakes. The constriction method is safe for humans as well. If the constriction method is chosen, the rodent is sized with two height array sensors and an actuator exerts sufficient force on the rodents' sides to simulate the constriction method. Sizing is necessary because rodents of different size requires a different amount of constriction for performing euthanasia. Once the rodent enters the system 100, an anti-exit door closes so it can not escape. Passageways lead up to the euthanasia chamber 125. Proper euthanasia is an important consideration. Alternatives include simply letting them freeze, electrocution, or a mechanical method.

The freezer unit 135 also includes several features. The freezer door 140 is super insulated and has a unique mechanism that raises the door 1/10^{th} inch at an inclined angle to break any ice seal before it slides open. When closing, the freezer door 140 seals by lowering it's self in place.

The freezer unit 135 is super insulated yet cost effective. In a typical embodiment, a NASA developed ceramic paint and NASA insulating plastic can be implemented. The freezer unit 135 also holds a disposable bag in place. Material selection or coating on internal freezer surfaces are used to prevent condensation from freezing the disposable bag to the sides of the freezer. Peltier thermoelectric devices are best for smaller volume freezing chambers. Efficient thermal transfer and condensation are important issues that are addressed. Thermal transfer considerations are addressed by using an efficient cold plate design. Condensation is eliminated by sealing and insulating the Peltier. A layered seal/insulate/seal construction is used for maximum efficiency. In one embodiment, several Peltier junctions function as the cooling mechanism. A cold plate is attached to the freezer unit 135. Peltiers are attached to the cold plate. Peltier junctions (especially multistage) have several operating characteristics that can be utilized to optimize their efficiency. Utilizing a Peltier for cooling is the preferred method for several reasons. First, there are no moving parts except for a small cooling fan. Second, peltiers only weigh approximately 1 Kg including heat sink and fan. This weight is much less than any of the alternative methods. A further advantage of peltiers is that since they include a hot and cold junction, the hot junction can be dissipated to the heating unit 120 to reduce additional energy needed to provide heat for the heating unit 120.

Many other freezing methods are also contemplated. For example, traditional evaporative cooling using Freon 134A or other types of refrigerant for larger units that have access to AC power can be implemented. This method is the most cost effective method for cooling large areas. This provides the necessary cooling to cool freezer sections up to 50 cubic feet in size.

In yet another embodiment, super cold CO2 or LN2 can be used for cooling and a portable power source powers the electronics. This method is particularly applicable for remote or underground locations that have no power available. A small battery or Fuel Cell provides power to the control system.

Electronic Control Functions are also contemplated. Peltier junctions (especially multistage) have several operating characteristics that can be utilized to optimize their efficiency. A unique approach which combines PWM (Pulse width modulation) and a closed loop non-interacting PID (Proportional, Integral, Derivative) control algorithms can double the run time of battery powered units. By performing the heat transfer in a sequential manner from one junction in the stack with the appropriate time base, the heat transfer can be optimized. By intentionally overdriving the Peltier, then allowing a few milliseconds for thermal transfer, then firing the next stage, a “heat pump” can be created. The target temperature for the freezer unit 135 is −17° C. to −28° C. A reverse polarity algorithm can be used for defrost and system 100 emptying. This method eliminates ice buildup and releases the bag during disposal if it happens to be frozen to the freezer compartment. In embodiments that implement battery/solar models, the freezer unit 135 is not cooled until a rodent is inducted to save power.

Integration of electronic hardware and creation of appropriate software to execute several functions that are now described.

Bait scent control logic is one function. The scent pellet (or liquid) is heated at periodic intervals to release scent attractant. Since most rodents feed in early morning and at night, the amount of scent release can be reduced during the daytime. This periodic method can extend the life of the scent attractant by significant amounts such as approximately 40%. The amount of scent released is tracked and notification issued that re-baiting is required.

The rodent detector sensor arrays 130 also require certain functionality. The detector arrays 130 typically include a vertically mounted infrared LED/Photodiode array that measures height in increments of 10 mm. By using a pair of arrays spaced at a predetermined horizontal distance from the height array, the length of the rodent can be estimated. This information is used to calculate the constriction force need to kill the rodent, count the number of rodents inducted, and estimate the volume of rodents in the freezer, among other information.

The anti exit actuator functionality is also considered. This “gate” traps rodent inside the euthanasia chamber 125 so they can not escape. The actuator includes open/close sensors for jam detection. If a jam is detected, an attempt is made to remove the jam by re-actuating the door up to a programmed number of times. If the Jam can not be cleared, a notification is issued that the anti exit door is jammed.

There is also euthanasia control logic functionality. Depending on the euthanasia method, different logic is used. For electrocution, a simple fire signal is issued to the high voltage circuitry inside the euthanasia chamber 125. For the constriction method, a calculated amount of pressure is exerted on the rodent, depriving it of oxygen.

There is further freezer door 140 actuator functionality. The freezer door 140 must be timed to induct the rodent after euthanasia has occurred. Door open/close sensors are included for jam detection. If a jam is detected, an attempt is made to remove the jam by re-actuating the door 140 up to a programmed number of times. If the freezer door 140 is still jammed, the Peltier junctions can be reversed to thaw out the door 140. This change in polarity does not result in the rodents thawing due to the short time period involved. If the jam can not be cleared, a notification is issued that the freezer door 140 is jammed.

Freezer load cell functionality is further considered. Load cell(s) can be located on freezer unit 135 for weighing carcass. When the freezer is weighed to be full, trapping stops and notification is issued that the system 100 is full.

The system 100 can further include LCD display functionality. A LCD display can display trap status, freezer temperature, number of catches, pounds in freezer and other system information can be included. When the catch bag is removed from the freezer, the number of catches is reset to zero and the load cell is tared to zero. A self test of approximately 15 seconds is run on all trap functions to ensure everything is functional before the service person leaves. If anything is found to be out-of spec, appropriate error messages are displayed.

The system 100 can further include radio/Modem/LAN connection functionality. A data connection for central office monitoring of trap status is programmed to accept status queries, self test, and enable/disable commands from the central office. Status queries include trap status, number of rodents in freezer, pounds of rodents in freezer, freezer temperature, and sizes of rodents being caught.

By installing permanent rodent elimination devices that do not have to be constantly monitored, existing rodent control personnel are enabled to become much more productive. Rather than visiting the systems 100 on a daily basis, they are able to make weekly or monthly system 100 checks. If their units are equipped with the remote monitoring option, they only have to service the systems 100 when they are full or need re-baiting. These features free up time and money for continued education of the public on how to prevent rat infestations. As described above, system 100 sizes range in sizes from single and multi catch models for the home owner to conduct self trapping efforts, medium sized systems 100 for industry and pest control companies, to large systems 100 for cities, DOD installations, and pest control companies.

The system 100 can be integrated into trash cans and dumpsters that automatically empty themselves when the trash is emptied by the trash truck. It can also be integrated into ornamental structures, sewer systems, or just about any other shape preference.

Any of the timing relationships and temperature control aspects can be advantageously be carried out in software using microprocessors and micro-controllers as needed.

The software techniques and methods discussed above can be implemented in digital electronic circuitry, or in computer hardware, firmware (as discussed), software, or in combinations of them. Apparatus may be implemented in a computer program product tangibly embodied in a machine-readable storage device for execution by a programmable processor; and methods may be performed by a programmable processor executing a program of instructions to perform functions by operating on input data and generating output. Further embodiments may advantageously be implemented in one or more computer programs that are executable on a programmable system including at least one programmable processor coupled to receive data and instructions from, and transmit data and instructions, to a data storage system, at least one input device, and at least one output device. Each computer program may be implemented in machine language or assembly language which can be assembled or translated, or a high level procedural or object-oriented programming language, which can be complied or interpreted. Suitable processors include, by way of example, both general and special purpose microprocessors. Generally, a processor receives instructions and data from read-only memory and or RAM. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially designed application specific integrated circuits (ASICs).

The foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

1. A rodent elimination system, comprising:
a housing having an upper section and a lower section;
a heated baiting device located in the upper section;
a euthanizing chamber having a rodent detector array located in the upper section;
a freezer unit located in the lower section; and
a freezer door typically separating the upper and lower sections.

2. The system as claimed in claim 1 further comprising a heated tube located in the baiting device.

3. The system as claimed in claim 2 further comprising temperature sensitive bait located within the baiting device.

4. The system as claimed in claim 1 further comprising a constriction system located within the euthanizing chamber.

5. The system as claimed in claim 1 further comprising an electrocution device located within the euthanizing chamber.

6. The system as claimed in claim 1 wherein the freezer unit is cooled by Peltier devices.

7. The system as claimed in claim 1 wherein the freezer unit is cooled by super cold CO2.

8. The system as claimed in claim 1 wherein the freezer unit is cooled by liquid nitrogen.

9. The system as claimed in claim 1 wherein the freezer unit is cooled by Freon refrigerant.

10. The system as claimed in claim 1 further comprising an exoskeleton located on the exterior of the housing.

11. The system as claimed in claim 1 further comprising a system status display.

12. The system as claimed in claim 1 further comprising a wireless, wired or infrared communication options.
